(19) United States
(12) Patent Application Publication
(10) Pub. No.: US 2024/0405269 A1
(43) Pub. Date: Dec. 5, 2024

(54) MULTILAYER SOLID ELECTROLYTE AND BATTERIES COMPRISING THEM

(71) Applicant: FUNDACIÓN CENTRO DE INVESTIGACIÓN COOPERATIVA DE ENERGÍAS ALTERNATIVAS CIC ENERGIGUNE FUNDAZIOA, Vitoria-Gasteiz, Álava (ES)

(72) Inventors: Pedro LÓPEZ-ARANGUREN, Vitoria-Gasteiz, Álava (ES); Ander ORUE, Vitoria-Gasteiz, Álava (ES); Frederic AGUESSE, Vitoria-Gasteiz, Álava (ES)

(21) Appl. No.: 18/697,435

(22) PCT Filed: Sep. 26, 2022
(86) PCT No.: PCT/EP2022/076619

§ 371 Date: Mar. 29, 2024

(30) Foreign Application Priority Data
Sep. 30, 2021 (EP) 21382883.3

(51) Int. Cl. H01M 10/0565; H01M 10/052; H01M 10/42

(52) U.S. Cl. CPC H01M 10/0565; H01M 10/052; H01M 10/4235; H01M 2300/0082; H01M 2300/0091; H01M 2300/0094

(57) ABSTRACT

A multi-layered solid electrolyte for Li- and Na-ion batteries has a dual conductive layer that is an ionic and electronic conductive layer, in combination with an ionic conductive and electronically insulating layer. A process is for preparation of the multi-layered solid electrolyte. A solid-state battery can be prepared with the multi-layered solid electrolyte.

### FIELD OF THE INVENTION

The present invention relates to the field of solid electrolytes, and more particularly to those used in lithium and sodium metal batteries. The invention also relates to the field of lithium and sodium batteries comprising solid electrolytes.

### BACKGROUND

Solid-state battery (SSB) is a promising electrochemical energy storage technology to power devices of our modern society. Solid electrolytes are believed to enable the use of Lithium-metal anode to provide a real jump in energy density, in comparison to conventional Li-ion Batteries (LIBs). However, there is still a long way to go for practical applications of SSBs. The growth and propagation of lithium dendrites from the Li metal anode to the positive electrode is still a problem even when solid electrolytes are used (Nature Energy, https://www.nature.com/article/energ2016141; R. Chen, et al., Chem. Rev., 2020, 120, 6820-6877).

Lithium propagation occurs from the Li metal to the positive electrode and when Li dendrite propagation connects both sides, the battery goes into short-cut limiting its shelf life. The propagation of lithium across the solid electrolyte may be due to the inhomogeneous electrodeposition of lithium at the Li metal electrode, likely due to presence of uneven current density distribution at the Li metal-solid electrolyte interface owing to inhomogeneous contact between those components.

Although the mechanism of dendrite growth is not fully understood, it is known that the interface between the Li metal and the solid electrolyte (SE) is a key player. The uneven contact between Li metal and SE is a source of inhomogeneous current density distribution along the surface of the electrode thus contributing to preferential spots for Li electroplating where Li metal will accumulate and will propagate across the thickness of the electrolyte towards the positive electrode. Dendrites are more likely to form at higher currents (i.e. faster charger/discharge of the battery) and higher area capacity loadings (i.e. larger amount of lithium plated and stripped by surface area).

The propagation of dendrites has been observed in solid-state batteries using both polymer and inorganic solid electrolytes.

In view of that, some efforts have been made in order to reduce dendrite formation and to improve and homogenize the current density at the Li metal-solid electrolyte interface.

Luhan Ye et al. (Nature, 2021, 593, 218-222) describes a cell structure for Li-metal batteries containing a multilayered electrolyte formed by the sequence graphite-LPSCl-LGPS-LPSCl-graphite. The central LGPS layer is a solid electrolyte of formula Li₁₀Ge₁P₂S₁₂, whereas LPSCl layers are solid electrolytes of formula Li_{5.5}PS_{4.5}Cl_{1.5}. By using the multilayer sequence graphite-LPSCl-LGPS-LPSCl-graphite in a symmetric battery, it has been shown that said battery can cycle at very high current densities (20 mA/cm2) with a low overpotential without notable signs of short-circuiting. The LPSCl layer helps to stabilize the primary interface to the Li/graphite layer and to lower the overall overpotential, making practical cycling at high current density possible, whereas the central LGPS layer exhibits an effect similar to an expansion screw effect (derived from a constrained decomposition which serves as a self-healing concrete to fill and heal any micrometer-sized cracks) reducing the Li dendrite formation.

Alemayehu et al., (Nanoscale, 2018, 10, 6125-6138) aims to minimise the formation of lithium dendrites, as well as the homogeneous deposition of lithium, in anode-free lithium-metal battery. For this purpose, the use of a copper electrode coated with a polyethylene oxide (PEO) film is disclosed in combination with an electrolyte made from a mixture of LiTFSI, 1,2-dimethoxyethane/1,3-dioxolane (DME/DOL) and LiNO₃ and a cathode of LifePO₄ or LiCoO₂.

The PEO film coating is shown to enhance lithium cycling and to supress dendrite formation by hosting deposited lithium and protecting it from excessive contact with the electrolyte. The interaction of lithium ions with the polar surface of PEO film coating provides good interfacial compatibility and regulates the flux of lithium ions during cycling.

On the other hand, polyethylene oxide is also widely used as solid polymer electrolyte in lithium-metal batteries. Although this polymer has ionic conductivity, this is reduced at temperatures below 65° C. mainly attributed to the transition from amorphous to crystalline structure. Therefore, PEO has been used in combination with a lithium salt having very large counter ion which interferes with the crystallization process, as well as with ceramic or oxide nanoparticles which act as effective cross-linking centres for PEO segments, thus lowering the reorganization of polymer chains and promoting localized amorphous regions.

Carbon additives have also been used into PEO electrolytes to improve the ionic conductivity and to enhance the amorphization of such polymer. However, due to the electronic conductivity of these compounds, they are not very suitable as solid electrolytes since the electrical conduction across the electrolyte provokes a short-circuiting. For example, the electrical conductivity of carbon nanotubes (CNTs) and the risk of battery shortening have restricted the application of these carbon additives in the field of polymer electrolytes. For this reason, some attempts have been made to reduce said electronic conductivity.

Ahn et al., (Metals and Materials International, 2006, 12 (1), 69-73) describes the use of small amounts and well-dispersed multi-walled carbon nanotubes (MWCNTs) on PEO-LiClO₄ electrolytes. Being in small quantities avoids direct electrical conduction across the electrolyte. In fact, it is concluded in this article that MWCNTs are more effective than oxide nanoparticles in terms of enhancing disordering of polymer chains and localized amorphization and therefore, the combination of PEO-LiClO₄-MWCNTs in an electrolyte increases the ionic conductivity by the above-referred promoting amorphous states.

Tang et al., (Nano Letters, 2012, 12, 1152-1156) describes the use of hybrid nanofillers to be incorporated in a PEO electrolyte which are based on carbon nanotubes packaged within insulating clay layers, particularly made of montmorillonite. These nanofillers not only allow increasing the lithium ion conductivity of PEO electrolyte as well as improving the mechanical properties of the polymer, but the electron conduction of carbon nanotubes is blocked by clay platelets that are attached to the CNTs, eliminating the risk of electrical shortening.

In spite of the different proposals made in the state of the art, there still exist a need to provide batteries comprising solid electrolytes having enhanced conductivity properties while reducing dendrite formation and improving the Li metal-solid electrolyte interface.

### BRIEF DESCRIPTION OF THE INVENTION

The authors of the present invention have shown that the use of a layer having dual conductivity (ionic and electronic) in an electrolyte having also a purely ionic conductivity layer allows preventing, or at least diminishing, the growth of lithium dendrites and reducing the internal resistance in a Li-metal solid-state battery.

This layer having dual conductivity properties is placed in contact with the Li metal of the anode and acts as a buffer layer for dendrite growth, while homogenizing the current distribution thanks to its electronic properties. In fact, the electronic conductivity on the dual conductive layer improves the distribution of the electronic current density at the interface between the Li metal anode and said electrolyte layer, thus blocking the lithium dendrite growth and propagation across the other electrolyte layer (purely ionic conductive layer).

The experimental results provided herein have shown that, in contrast to lithium batteries having an ionic conductivity layer as a sole component of the electrolyte, the electrolyte of the present invention withstands the whole rate capability with currents from 0.05 C up to 4 C and is able to recover back to 0.1 C with no evidence of dendrite formation. Furthermore, the full cell containing the electrolyte layer displays higher discharge capacity values at high currents. The same is also expected for Na-metal batteries.

Therefore, a first aspect of the present invention refers to a multilayer solid electrolyte for Li- and Na-ion batteries, said electrolyte comprising:
a) an ionic conductive and electronically insulating layer comprising:
   an ion conductive polymer, and at least a lithium or a sodium salt; or
   an inorganic solid material:
b) an ionic and electronic conductive layer comprising:
   an ion conductive polymer, at least a lithium or a sodium salt, and a electronically conductive additive; or
   an inorganic solid material and an electronically conductive additive.

A second aspect of the invention refers to a process to obtain the multilayer solid electrolyte, said process comprises:
a) providing an ionic conductive and electronically insulating layer comprising:
   an ion conductive polymer, and at least a lithium or a sodium salt; or
   an inorganic solid material:
b) providing an ionic and electronic conductive layer comprising:
   an ion conductive polymer, at least a lithium or a sodium salt, and an electronically conductive additive; or
   an inorganic solid material and an electronically conductive additive:
c) placing the ionic and electronic conductive layer provided in step b) on top of the ionic conductive and electronically insulating layer provided in step a)

Another aspect of the present invention relates to an electrochemical Na- or Li-ion or Na- or Li-metal cell or a Na- or Li-ion battery or a Na- or Li-metal battery comprising the multilayer solid electrolyte as defined above.

### DESCRIPTION OF FIGURES

FIG. 1. Schematic representation of the two configurations used for testing the stripping plating abilities of the solid electrolyte. a) symmetric Li metal cells. b) Li-metal full cells.

FIG. 2. Stripping plating test of the symmetric cells including the solid electrolyte layer 1 (a, b) and the layer 1 and layer 2 (c—speed mode is on). The tests were performed at 0.2 and 0.5 mAh·cm⁻² for the former, and at 0.5 mAh·cm⁻² for the latter. Rate capability was examined from 0.05 C up to 4 C.

FIG. 3. Schematic representation of cell 1 and cell 2 (left) and discharge capacity of the cells under rates from C/20 up to 2 C.

FIG. 4. Electrochemical impedance spectroscopy plots of Li metal symmetric cells with (a) layer 1 (cell 1) and (b) layer 2 (cell 2) measured at RT.

### DETAILED DESCRIPTION OF THE INVENTION

As mentioned above, the first aspect of the present invention refers to a multilayer solid electrolyte for Li- and Na-ion batteries, said electrolyte comprising:
a) an ionic conductive and electronically insulating layer comprising:
   an ion conductive polymer, and at least a lithium or a sodium salt; or
   an inorganic solid material;
b) an ionic and electronic conductive layer comprising:
   an ion conductive polymer, at least a lithium or a sodium salt, and an electronically conductive additive; or
   an inorganic solid material and an electronically conductive additive.

The ionic conductive and electronically insulating layer (a) and the ionic and electronic conductive layer (b) will also be referred to in the present document as layer 1 and layer 2, respectively.

In the context of the present invention, a “multilayer” is used as a general term to embrace a structure comprising at least a first layer covered or coated, partially or fully, by at least another layer. Hence, in its simplest form, the multilayer is a bilayer.

In a preferred embodiment, the multilayer solid electrolyte is for Li-ion batteries, said electrolyte comprising:
a) an ionic conductive and electronically insulating layer comprising:
   an ion conductive polymer and at least a lithium salt; or
   an inorganic solid material:
b) an ionic and electronic conductive layer comprising:
   an ion conductive polymer, at least a lithium salt, and an electronically conductive additive; or
   an inorganic solid material and an electronically conductive additive.

In a particular embodiment, the ionic conductive and electronically insulating layer (a) comprises an ion conductive polymer, and at least a lithium or a sodium salt. In a more particular embodiment, the ionic conductive and electronically insulating layer (a) comprises an ion conductive polymer and at least a lithium salt.

In another particular embodiment, the ionic conductive and electronically insulating layer (a) consists of a mixture of an ion conductive polymer, and a lithium or sodium salt. In a more particular embodiment, the ionic conductive and electronically insulating layer (a) consists of a mixture of an ion conductive polymer and a lithium salt.

Non-limiting examples of said ion conductive polymers are polyethylene oxide (PEO) derivatives, polypropylene oxide (PPO) derivatives, polytetrahydrofurane (poly THF) derivatives, poly vinylidene fluoride (PVDF), and polymers including ionic dissociative groups. A combination comprising at least one of the foregoing may also be used.

More preferably, the ion conductive polymer is an ion conductive polymer having alkylene oxide-based segment.

The phrase “ion conductive polymer having an alkylene oxide-based segment” as used herein refers to an ion conductive polymer having an alkylene oxide chain structural unit in which alkylene groups and ether oxygen groups are alternately arranged.

The alkylene oxide chain structural unit may be included in a main chain of the ion conductive polymer, or may be included, in a grafted form, in the ion conductive polymer. For example, the alkylene oxide chain structural unit may be an alkylene oxide chain structural unit having 8 to 500.000 carbon atoms, for example, 40 to 250.000 carbon atoms. In some embodiments, the alkylene oxide chain structural unit may be branched or have a comb-like structure.

The ion conductive polymer may include a siloxane-based polymer or an acrylate-based polymer, a poly(alkene-alt-maleic anhydride) polymer to which is attached the alkylene oxide-based polymer. The ion conductive polymer may comprise at least one selected from an alkylene oxide-based polymer blend, a siloxane-based polymer blend, and an acrylate-based polymer blend a poly(alkene-alt-maleic anhydride) polymer.

In a particular embodiment, the ion conductive polymer may be at least one selected from polyethylene oxide (PEO), polypropylene oxide (PPO), polybutylene oxide (PBO), a PEO-PPO blend, a PEO-PBO blend, a PEO-PPO—PBO blend, a PEO-PPO block copolymer, a PEO-PBO block copolymer, a PEO-PPO—PBO block copolymer, a PBO-PEO-PBO block copolymer, a PEO-PBO-PEO block copolymer, PEO-grafted polymethyl methacrylate (PMMA), PPO-grafted PMMA, and PBO-grafted PMMA, a PEO/PPO-grafted poly(alkene-alt-maleic anhydride) polymer.

More particularly, the ion conductive polymer may be at least one selected from PEO, PPO, a PEO/PPO-grafted poly(alkene-alt-maleic anhydride) polymer, a PEO-PPO blend, a PEO-PPO block copolymer, a PEO-PPO-PEO block copolymer and a polystyrene-PEO block polymer. In a most preferred embodiment, the ion conductive polymer is PEO. The ion conductive polymer may have a weight average molecular weight (Mw) of from about 100,000 Daltons to about 7,000,000 Daltons. The weight average molecular weight (Mw) of the ion conductive polymer may be, for example, from about 200.000 Daltons to about 7,000,000 Daltons, for example, from about 300.000 Daltons to about 5,000,000 Daltons. The ion conductive polymer having the weight average molecular weight (Mw) within the ranges described above has an appropriate chain length, i.e., an appropriate degree of polymerization and thus may have enhanced ionic conductivity at room temperature. However, the weight average molecular weight (Mw) of the ion conductive polymer is not particularly limited to the above ranges and may be within any range that enhances the ionic conductivity of the electrolyte composition or represents gains in the mechanical properties.

Regarding the lithium salt, any lithium salt may be used in the present invention. However, lithium salts having good ionic conductivity due to a low lattice energy (i.e., high degree of dissociation), and high thermal stability and oxidation resistance are preferred.

Examples of lithium salts which can be used in the present invention include, but are not limited to, lithium tetrafluoroborate LiBF₄, lithium hexafluorophosphate LiPF₆, lithium hexafluoroarsenate LiA₅F₆, lithium iodide LiI, lithium trifluoromethane sulfonate LiCF₃SO₃, lithium bis(trifluoromethanesulfonyl)imide Li[(CF₃SO₂)₂N], lithium bis(perfluoroethylsulfonyl)imide Li[(CF₃CF₂SO₂)₂N], Li[(C₂F₅SO₂)₂N], lithium bis(fluorosulfonyl)imide Li[(FSO₂)₂N], lithium (trifluoromethanesulfonyl) (fluorosulfonyl)imide Li[(CF₃SO₂)(FSO₂)N], Li[(FSO₂)(C₄F₉SO₂)N], lithium (perfluoroethylsulfonyl)(fluorosulfonyl)imide Li[(FSO₂)(CF₃CF₂SO₂)N], lithium perchlorate LiClO₄, lithium bis(oxalato) borate LiB(C₂O₄)₂, lithium oxalatodifluoroborate Li[BF₂C₂O₄], the lithium salt of 4,5-dicyano-1,2,3-triazole, the lithium salt of 4,5-dicyano-2-trifluoromethyl-imidazole, the lithium salt of 4,5-dicyano-2-pentafluoroethyl-imidazole, or mixtures thereof.

In a preferred embodiment, the lithium salt is selected from lithium trifluoromethane sulfonate LiCF₃SO₃, lithium bis(trifluoromethanesulfonyl)imide Li[(CF₃SO₂)₂N], lithium bis(perfluoroethylsulfonyl)imide Li[(CF₃CF₂SO₂)₂N], lithium (trifluoromethanesulfonyl)(fluorosulfonyl)imide Li[(CF₃SO₂)(FSO₂)N], Li[(C₂F₅SO₂)₂N], lithium bis(fluorosulfonyl)imide Li[(FSO₂)₂N], Li[(FSO₂)(C₄F₉SO₂)N] and lithium (perfluoroethylsulfonyl)(fluorosulfonyl)imide Li[(FSO₂)(CF₃CF₂SO₂)N]. Even more preferably, the lithium salt is lithium bis(trifluoromethanesulfonyl)imide Li[(CF₃SO₂)₂N] or lithium (trifluoromethanesulfonyl)(fluorosulfonyl)imide Li[(CF₃SO₂)(FSO₂)N] and most preferably, the lithium salt is bis(trifluoromethanesulfonyl)imide Li[(CF₃SO₂)₂N].

In a preferred embodiment, the ionic conductive and electronically insulating layer (a) comprises:
an ion conductive polymer selected from PEO, PPO, a PEO/PPO-grafted poly(alkene-alt-maleic anhydride) polymer, a PEO-PPO blend, a PEO-PPO block copolymer, and a PEO-PPO-PEO block copolymer and a polystyrene-PEO block polymer; and
at least a lithium salt selected from LiCF₃SO₃, Li[(CF₃SO₂)₂N], Li[(CF₃CF₂SO₂)₂N], Li[(CF₃SO₂)(FSO₂)N], Li[(C₂F₅SO₂)₂N], Li[(FSO₂)₂N], Li[(FSO₂)(C₄F₉SO₂)N] and Li[(FSO₂)(CF₃CF₂SO₂)N].

In a most preferred embodiment, ionic conductive and electronically insulating layer (a) comprises:
PEO as ion conductive polymer, and
a lithium salt selected from Li[(CF₃SO₂)₂N] and Li[(CF₃SO₂)(FSO₂)N].

In an even most preferred embodiment, the ion conductive polymer is PEO and the lithium salt is bis(trifluoromethanesulfonyl)imide Li[(CF₃SO₂)₂N].

In another particular embodiment, the lithium salt to ion conductive polymer molar ratio varies from 1:10 to 1:30, more preferably from 1:15 to 1:25, and even more preferably is 1:20.

As mentioned above, the multilayer electrolyte of the invention can also be implemented in sodium-ion batteries. In this particular case, the sodium salt is preferably a salt having good ionic conductivity (i.e., high degree of dissociation), and high thermal stability and oxidation resistance, as also required for lithium salts.

Examples of sodium salts which can be used in the present invention include, but are not limited to, Na[R¹SO₂NSO₂R²] wherein R¹ and R² are independently selected from fluorine or a fluoroalkyl group, NaCF₃SO₃, NaC(CN)₃, NaB(C₂O₄)₂ and NaBF₂(C₂O₄), NaSbF₆, NaAsF₆, NaBF₄, NaClO₄, NaPF₆ and a mixture thereof.

In a preferred embodiment, the sodium salt is Na[R¹SO₂NSO₂R²], wherein R¹ and R² are independently selected from F and CF₃, more preferably both are F or both are CF₃. When R¹ and R² are both F, the resulting anion is bis(fluorosulfonyl)imide anion (also referred to as “FSI anion”). When R¹ and R² are both CF₃, the resulting anion is bis(trifluoromethylsulfonyl)imide anion (also referred to as “TFSI anion”). Thus, the use of NaFSI or NaTFSI is preferred.

In another particular embodiment, the ionic conductive and electronically insulating layer comprises an inorganic solid material.

Said inorganic solid material comprises or is made of a material selected from ceramics, such as garnets, more particularly cubic garnets, e.g. Li₇La₃Zr₂O₁₂, or such as β-aluminas, e.g. Li-β-alumina; perovskites, such as Li_{3.3}La_{0.56}TiO₃; argyrodites, such as Li₆PS₅Cl; sulfides, such as Li₂S—P₂S₅; hydrides, such as LiBH₄; halides, such as LiI; NASICONS, such as LiTi₂(PO₄)₃, Li₃Zr₂(SiO₄)₂ (PO₄); LISICONs, such as Li₁₄Zn(GeO₄)₄; borates, such as Li₂B₄O₇; and phosphates, such as Li₃PO₄, Li_{1.3}Al_{0.3}Ti_{1.7}(PO₄)₃ and Li_{1.3}Al_{0.3}Ge_{1.7}(PO₄)₃. The inorganic solid material preferably comprises or is made of a garnet, more preferably a lithium garnet.

Examples of lithium garnets include Li₅-phase lithium garnets, e.g., Li₅La₃M¹₂O₁₂, where M¹ is Nb, Zr, Ta, Sb, or a combination thereof: Li₆-phase lithium garnets, e.g. Li₆DLa₂M³₂O₁₂, where D is Mg, Ca, Sr, Ba, or a combination thereof and M³ is Nb, Ta, or a combination thereof; and Liz-phase lithium garnets, e.g., cubic Li₇La₃Zr₂O₁₂ and Li₇Y₃Zr₂O₁₂.

In a particular embodiment, the ionic and electronic conductive layer (b) comprises an ion conductive polymer, at least a lithium or a sodium salt, and an electronically conductive additive. In a more particular embodiment, the ionic and electronic conductive layer (b) comprises an ion conductive polymer, at least a lithium salt, and an electronically conductive additive.

In another particular embodiment, the ionic and electronic conductive layer (b) layer consists of a mixture of an ion conductive polymer, a lithium or a sodium salt, and an electronically conductive additive. In a more particular embodiment, the ionic and electronic conductive layer (b) layer consists of a mixture of an ion conductive polymer, a lithium salt and an electronically conductive additive.

Any of the ion conductive polymer, lithium salts and sodium salts mentioned above for the ionic conductive and electronically insulating layer can also apply for the ionic and electronic conductive layer (b), including the particular and preferred embodiments.

In another particular embodiment, the ionic and electronic conductive layer (b) comprises an inorganic solid material and an electronically conductive additive.

Any of the inorganic solid material mentioned above for the ionic conductive and electronically insulating layer can also apply for the ionic and electronic conductive layer (b), including the particular and preferred embodiments.

Regarding the electronically conductive additive, non-limiting examples thereof include any conductive carbons such as carbon, graphite, graphite powder, graphite powder flakes, graphite powder spheroids, carbon black, activated carbon, conductive carbon, amorphous carbon, glassy carbon, acetylene black, single walled carbon nanotubes, multi-walled carbon nanotubes, graphene, graphyne, or any combinations thereof. More preferably is the use of single walled carbon nanotubes or multi-walled carbon nanotubes.

In some embodiments, the electronically conductive additive can have a particle size ranging from about 1 to about 50 microns, or between about 2 and about 30 microns, or between about 5 and about 15 microns.

The amount of the electronically conductive additive can be as low as 0.1 wt % and as high as the layer (b) can be processed. In a particular embodiment, the total electronically conductive additive weight percentage in the electrolyte layer (b) can range from about 5 wt % to 20 wt %, more preferably from 5 to 10 wt %, wherein the weight percentage is given with respect to the total weight of the electrolyte layer (b).

In a preferred embodiment, the ionic and electronic conductive layer (b) comprises:
an ion conductive polymer selected from PEO, PPO, a PEO/PPO-grafted poly(alkene-alt-maleic anhydride) polymer, a PEO-PPO blend, a PEO-PPO block copolymer, and a PEO-PPO-PEO block copolymer and a polystyrene-PEO block polymer;
a lithium salt selected from LiCF₃SO₃, Li[(CF₃SO₂)₂N], Li[(CF₃CF₂SO₂)₂N], Li[(CF₃SO₂)(FSO₂)N], Li[(C₂F₅SO₂)₂N], Li[(FSO₂)₂N], Li[(FSO₂)(C₄F₉SO₂)N] and Li[(FSO₂)(CF₃CF₂SO₂)N]; and
an electronically conductive additive selected from single walled carbon nanotubes, multi-walled carbon nanotubes, graphene, and graphite.

In a most preferred embodiment, the ionic and electronic conductive layer (b) comprises:
PEO as ion conductive polymer;
a lithium salt selected from Li[(CF₃SO₂)₂N] and Li[(CF₃SO₂)(FSO₂)N]; and
an electronically conductive additive selected from single walled carbon nanotubes, multi-walled carbon nanotubes, graphene, graphite, and carbon black.

Within this preferred embodiment, the lithium salt to PEO conductive polymer molar ratio can vary from 1:10 to 1:30, more preferably from 1:15 to 1:25, and even more preferably is 1:20.

Also, within this preferred embodiment, the electronically conductive additive can be present in a weight percentage ranging from 5 to 10 wt % with respect to the total weight of the ionic and electronic conductive layer (b).

A second aspect of the present invention refers to a process for preparing the solid electrolyte as defined above, said method comprises:
a) providing an ionic conductive and electronically insulating layer comprising:
   an ion conductive polymer, and at least a lithium or sodium salt; or
   an inorganic solid material:
b) providing an ionic and electronic conductive layer comprising:
   an ion conductive polymer, at least a lithium or a sodium salt, and an electronically conductive additive; or
   an inorganic solid material and an electronically conductive additive:
c) placing the ionic and electronic conductive layer provided in step b) on top of the ionic conductive and electronically insulating layer provided in step a).

In a particular embodiment, step a) of the process of the invention consists in the provision of an ionic conductive and electronically insulating layer comprising an ion conductive polymer, and a lithium or sodium salt.

Within this particular embodiment, the at least one lithium or sodium salt and the ion conductive polymer can be dissolved in a common volatile solvent.

Examples of volatile solvents include, but are not limited to, methanol, ethanol, isopropanol, acetone, methyl-ethyl-ketone, acetonitrile, ethyl acetate, methyl- or ethyl-formate, dichloromethane. The man skilled in the art will be able to choose the solvent or the mixture of solvents according to the best properties required in the end product.

In a particular embodiment, the lithium or sodium salt to ion conductive polymer molar ratio varies from 1:10 to 1:30, more preferably from 1:15 to 1:25, and even more preferably is 1:20.

The resulting solution is viscous and can be poured onto a substrate, such as a Teflon plate, to subsequent evaporate the solvent. An electrolyte layer or membrane with a controlled thickness can be obtained by any method known by those skilled in the art, such as by hot-pressing the as-obtained Li or Na salt/polymer mixture.

In a preferred embodiment, by step a) it is provided an ionic conductive and electronically insulating layer comprising:
an ion conductive polymer, and at least a lithium salt; or
an inorganic solid material.

More preferably, by step a) it is provided an ionic conductive and electronically insulating layer comprising an ion conductive polymer and at least a lithium salt.

In another particular embodiment, step b) of the process of the invention consists in the provision of an ionic and electronic conductive layer comprising an ion conductive polymer, at least a lithium or sodium salt, and an electronically conductive additive.

This can be done by the same method as described above for the provision of the ionic conductive and electronically insulating layer (step a) of the process of the invention) but with the addition of the electronically conductive additive to the solution containing the ion conductive polymer and the at least lithium or sodium salt.

In another particular embodiment, step b) of the process of the invention consists in the provision of an ionic and electronic conductive layer comprising an inorganic solid material and an electronically conductive additive. Within this particular embodiment, the electronically conductive additive can be added to a solution containing the inorganic material. Alternatively, the components are mixed by means of, for example, planetary milling, a mortar, or any other mixer.

The present invention is also directed to a half-cell, cell or battery (SSB) comprising the multilayer solid electrolyte of the invention of any of the embodiments described herein.

The half-cell or cell further comprises a cathode-side and/or an anode-side.

The battery can comprise a plurality of said cells, in particular where each adjacent pair of said cells is separated by a separator, which can be a bipolar plate.

In an embodiment, the SSB of the invention is a lithium battery. Lithium batteries encompass both lithium ion batteries and lithium metal batteries. In a preferred embodiment, the SSB is a lithium-ion battery.

In an embodiment, the SSB of the invention is a lithium ion battery or a lithium metal battery. As the skilled person will derive from common general knowledge, said embodiment does not encompass a lithium-sulfur battery.

In another embodiment, the SSB of the invention is a sodium battery. Sodium batteries encompass both sodium ion batteries and sodium metal batteries. In a preferred embodiment, the SSB is a sodium-ion battery.

In an embodiment, the SSB of the invention is a sodium ion battery or a sodium metal battery. As the skilled person will derive from common general knowledge, said embodiment does not encompass a sodium-sulfur battery.

Actually, a further aspect of the invention refers to a cell or battery comprising:
a) a multilayer solid electrolyte as defined above and;
b) a negative electrode; and
c) a positive electrode,
wherein the layer a) of the solid electrolyte is in contact with the positive electrode and the layer b) of the solid electrolyte is in contact with the negative electrode.

More preferably, the battery is a lithium battery, more preferably is a secondary lithium battery.

Secondary lithium batteries are lithium batteries which are rechargeable. The combination of the electrolyte and the negative electrode of such batteries must be such as to enable both plating/alloying (or intercalation) of lithium onto the electrode (i.e. charging) and stripping/dealloying (or de-intercalation) of lithium from the electrode (i.e. discharging).

It should be pointed out that the terms anode and cathode as commonly used in battery literature can be confusing and misleading, particularly in connection with rechargeable/secondary batteries and this is the reason to include the terms negative electrode and positive electrode in the composition of the battery of the invention as they confer a more correct designation.

The negative electrode corresponds to what is usually called the anode, and the positive electrode corresponds to what is usually called cathode. Accurately speaking, the negative electrode is only an anode (the electrode at which an oxidation reaction is taking place) during the discharge process. During recharge, the negative electrode operates as a cathode (the electrode at which a reduction reaction is taking place). Correspondingly, the positive electrode operates as a cathode during discharge only. During recharge, the positive electrode operates as an anode. Thus, as used throughout this application, the terms negative and positive electrodes are employed and are to be read consistent with the terminology of this paragraph.

Furthermore, the battery of the invention can include a metal foil current collector to conduct current to and from the positive and negative electrodes.

The negative electrode of the lithium battery of the invention usually comprises a substrate and a negative electrode material.

The substrate may also have the role of current collector in the battery. Thus, the substrate can be a metal substrate made by any suitable metal or alloy, and may for instance be formed from one or more of the metals Pt, Au, Ti, Al, W, Cu or Ni.

The negative electrode material can be metal lithium; a lithium alloy forming material, or a lithium intercalation material. Lithium can be reduced onto/into any of these materials electrochemically in the device.

Particularly preferred are Li metal electrodes and electrodes comprising Li alloyed with Al, Bi, Cd, Mg, Sn, or Sb, In, such as Li—Al. More preferably, the negative electrode is a Li metal electrode.

The positive electrode may be formed from any typical lithium intercalation material, such as transition metal oxides and their lithium compounds.

Examples of suitable active materials for the positive electrode are lithium metal oxides, such as
lithium nickel-rich layered oxide of formula Li_{y}Ni₁₋ₓMₓO₂, wherein M represents at least one metal and 0≤x≤1, 0.8≤y≤1.2;
spinel oxide of formula LiNi₂₋ₓMxO₄, wherein M represents at least one transition metal and 0≤x≤2;
lithium-rich layered oxide of formula Li₁₊ₓM₁₋ₓO₂ wherein M represents at least one transition metal and 0≤x≤1;
lithium polyanion of formula Li₂MSiO₄ wherein M is Mn, Co or Ni; of formula LiMPO₄ wherein M is Co or Ni; of formula Li₂MP₂O₇ wherein M is Mn, Co or Ni; or of formula Li₃V₂(PO₄)₃, Li₂VOP₂O₇, or LiVP₂O₇; or
phosphate or sulfate of formula Li_{y}MXO₄Z; wherein y is 0, 1, 2; M is a transition metal; X is P or S; Z is F, O or OH.

In a preferred embodiment, the cathode active material is a lithium nickel-rich layered oxide of formula Li_{y}Ni₁₋ₓMₓO₂, wherein M represents at least one metal and 0≤x≤1, 0.8≤y≤1.2. Preferably, M represents at least one of Fe, Co, Mn, Cu, Zn, Al, Sn, B, Ga, Cr, V, Ti, Mg, Ca, and Sr, more preferably it represents at least one of Co, Mn, and Al, and most preferably it represents Co and Mn. Preferably, x is in the range from 0.01 to 0.5. Examples of suitable active materials, which can be eventually surface treated and/or slightly overlithiated are LiNi_{1/3}Co_{1/3}Mn_{1/3}O₂, LiNi_{0.5}Co_{0.2}Mn_{0.3}O₂ LiNi_{0.4}Co_{0.2}Mn_{0.4}O₂, LiNi_{0.8}Co_{0.15}Al_{0.05}O₂, LiNi_{0.8}Co_{0.1}Mn_{0.1}O₂, LiNi_{0.85}Co_{0.05}Mn_{0.1}O₂, LiNi_{0.84}Co_{0.06}Mn_{0.09}Al_{0.01}O₂, LiNi_{0.85}Mg_{0.15}O₂.

In an embodiment, the cathode active material is a spinel oxide of formula LiNi₂₋ₓMₓO₄, wherein M represents at least one transition metal and 0≤x≤2. Preferably, M represents at least one of Mn and Ti, Examples of suitable active materials are LiNi_{0.5}Mn_{1.5}O₄, LiNi_{0.5}Mn_{1.2}Ti_{0.3}O₄, preferably LiNi_{0.5}Mn_{1.5}O₄.

In an embodiment, the cathode active material is a lithium-rich layered oxide of formula Li₁₊ₓM₁₋ₓO₂ wherein M represents at least one transition metal and 0≤x≤1. M preferably represents at least one of Mn, Ni and Co. Preferably, the lithium-rich layered oxide is represented by formula xLi₂MnO₃(1-x)LiMO₂ wherein M represents at least one metal and 0≤x≤1. Examples of suitable active materials are Li_{1.2}Mn_{0.54}Ni_{0.13}Co_{0.13}O₂, Li_{1.2}Mn_{0.6}Ni_{0.2}O₂, which can also be expressed as 0.5 Li₂MnO₃·0.5 LiNi_{1/3}Co_{1/3}Mn_{1/3}O₂ and 0.5 Li₂MnO₃·0.5 LiNi_{0.5}Mn_{0.5}O₂, respectively; Li_{1.2}Co_{0.4}Mn_{0.4}O₂, Li_{1.3} Nb_{0.3}Mn_{0.4}O₂.

In an embodiment, the cathode active material is a lithium polyanion of formula Li₂MSiO₄ wherein M is Mn, Co or Ni; of formula LiMPO₄ wherein M is Fe, Mn, Co or Ni; of formula Li₂MP₂O₇ wherein M is Mn, Co or Ni; or of formula Li₃V₂(PO₄)₃, Li₂VOP₂O₇, or LiVP₂O₇.

In an embodiment, the cathode active material is a phosphate or sulfate of formula Li_{y}MXO₄Z; wherein y is 0, 1, 2; M is a transition metal; X is P or S; Z is F, O or OH. M preferably represents one of Co, Ni, Mn, V and Fe. Preferably, the material has a tavorite structure. More preferably, the positive electrode comprises or is made of LiFePO₄.

As known in the art, transition metal oxide composite material can be mixed with a binder such as a polymeric binder, and any conductive additives before being applied to or formed into a current collector of appropriate shape.

In an embodiment, the positive electrode comprises an active material selected from lithium metal oxides and lithium-based olivines.

In a preferred embodiment, the cell or battery comprises lithium metal as negative electrode and LiFePO₄ as positive electrode.

In another embodiment, the battery is a sodium battery, more preferably is a secondary sodium battery.

Within this embodiment, the negative electrode and the positive electrode are homologues of the above defined negative and positive electrodes for lithium batteries wherein the Li is replaced by Na.

Cathodes as described herein are commercially available and well known in the art, such as from Li et al., Chem Soc Rev, 2017, 46, 3006-3059, or Lyu et al., Sustainable Materials and Technologies, 2019, 21, e00098.

When electrodes and multilayer solid electrolyte are assembled to form an electrochemical cell or half-cell, the layer 1 of the electrolyte is disposed on the surface of the negative electrode, whereas the layer 2 of the electrolyte is disposed on the surface of the positive electrode.

More particularly, for the assembly of a full cell including the multilayer solid electrolyte the layers are stacked by placing the components on top of each other, namely the layer 1 of the electrolyte is placed on top of the positive electrode, then, the layer 2 is placed on top of the layer 1 and finally the negative electrode is placed on top of layer 2.

The present invention is also directed to the use of the multilayer solid electrolyte, half-cell, cell or battery for energy storage in an electronic article such as computers, smartphones, or portable electronics (e.g. wearables); in a vehicle such as automobiles, aircrafts, ships, submarines or bicycles; or in an electrical power grid such as those associated to solar panels or wind turbines.

### Clauses (Further Embodiments)

1. A multilayer solid electrolyte for Li- and Na-ion batteries, said solid electrolyte comprising:
   a) an ionic conductive and electronically insulating layer comprising:
      an ion conductive polymer, and at least a lithium or a sodium salt; or
      an inorganic solid material:
   b) an ionic and electronic conductive layer comprising:
      an ion conductive polymer, at least a lithium or a sodium salt, and an electronically conductive additive; or
      an inorganic solid material and an electronically conductive additive.
2. The solid electrolyte according to clause 1, wherein the ionic conductive and electronically insulating layer comprises an ion conductive polymer and at least a lithium salt.
3. The solid electrolyte according to clause 1, wherein the ionic and electronic conductive layer comprises an ion conductive polymer, at least a lithium salt and an electronically conductive additive.
4. The solid electrolyte as defined in clauses 2 or 3, wherein the ion conductive polymer is selected from polyethylene oxide, polypropylene oxide, a polyethylene oxide/polypropylene oxide-grafted poly(alkene-alt-maleic anhydride) polymer, a polyethylene oxide-polypropylene oxide blend, a polyethylene oxide-polypropylene oxide block copolymer, a polyethylene oxide-polypropylene oxide-polyethylene oxide block copolymer and a polystyrene-polyethylene oxide block polymer.
5. The solid electrolyte as defined in clause 4, wherein the ion conductive polymer is polyethylene oxide.
6. The solid electrolyte as defined in any of clauses 2 to 5, wherein the at least lithium salt is selected from lithium trifluoromethane sulfonate LiCF₃SO₃, lithium bis(trifluoromethanesulfonyl)imide Li[(CF₃SO₂)₂N], lithium bis(perfluoroethylsulfonyl)imide Li[(CF₃CF₂SO₂)₂N], lithium (trifluoromethanesulfonyl)(fluorosulfonyl)imide Li[(CF₃SO₂)(FSO₂)N], Li[(C₂F₅SO₂)₂N], lithium bis(fluorosulfonyl)imide Li[(FSO₂)₂N], Li[(FSO₂)(C₄F₉SO₂)N] and lithium (perfluoroethylsulfonyl)(fluorosulfonyl)imide Li[(FSO₂)(CF₃CF₂SO₂)N].
7. The solid electrolyte according to any of clauses 1 to 6, wherein the electronically conductive additive is selected from carbon, graphite, graphite powder, graphite powder flakes, graphite powder spheroids, carbon black, activated carbon, conductive carbon, amorphous carbon, glassy carbon, acetylene black, single walled carbon nanotubes, multi-walled carbon nanotubes, graphene, graphyne, and any combinations thereof.
8. The solid electrolyte according to any of clauses 1 to 7, wherein the ionic conductive and electronically insulating layer (a) comprises:
   a) polyethylene oxide as the ion conductive polymer, and
   b) a lithium salt selected from Li[(CF₃SO₂)₂N] and Li[(CF₃SO₂)(FSO₂)N].
9. The solid electrolyte according to any of clauses 1 to 8, wherein the ionic and electronic conductive layer comprises:
   a) polyethylene oxide as the ion conductive polymer, and
   b) a lithium salt selected from Li[(CF₃SO₂)₂N] and Li[(CF₃SO₂)(FSO₂)N]; and
   c) an electronically conductive additive selected from single walled carbon nanotubes, multi-walled carbon nanotubes, graphene, graphite and carbon black.
10. A process to prepare the multilayer solid electrolyte as defined in any of clauses 1 to 9, said process comprises:
   a) providing an ionic conductive and electronically insulating layer comprising:
      an ion conductive polymer, and at least a lithium or a sodium salt; or
      an inorganic solid material:
   b) providing an ionic and electronic conductive layer comprising:
      an ion conductive polymer, at least a lithium or a sodium salt, and an electronically conductive additive; or
      an inorganic solid material and an electronically conductive additive:
   c) placing the ionic and electronic conductive layer provided in step b) on top of the ionic conductive and electronically insulating layer provided in step a).
11. An electrochemical Li-cell or a Li-battery comprising a multilayer solid electrolyte as defined in any one of clauses 1 to 9.
12. The electrochemical Li-cell or Li-battery according to clause 11 comprising:
   a) a multilayer solid electrolyte as defined in any of clauses 1 to 9
   b) a negative electrode; and
   c) a positive electrode,
      wherein the layer a) of the multilayer solid electrolyte is in contact with the positive electrode and the layer b) of the multilayer solid electrolyte is in contact with the negative electrode.
13. The electrochemical cell or battery according to clause 12, wherein the multilayer solid electrolyte comprises:
   a) an ionic conductive and electronically insulating layer comprising an ion conductive polymer and at least a lithium salt;
   b) an ionic and electronic conductive layer comprising an ion conductive polymer, at least a lithium salt and an electronically conductive additive.
14. The electrochemical cell or battery according to any of clauses 12 or 13, wherein the negative electrode comprises a material selected from metal lithium, a lithium alloy forming material and a lithium intercalation material.
15. The electrochemical cell or battery according to any of clauses 12 to 14, wherein the positive electrode comprises an active material selected from lithium metal oxides, lithium sulfides and lithium-based olivines.

The present invention will now be described in further detail with reference to the following non-limiting examples.

### EXAMPLES

### Example 1. Preparation of Solid Electrolyte

The ionic conductive and electronically insulating layer (layer 1) was prepared from a mixture of lithium bis(trifluoromethanesulfonyl)imide, also known as LiTFSI, with polyethylene oxide (Mw=5 M). The formulation of the layer was fixed to an ethylene oxide:Li molar ratio of 20:1.

The ionic and electronic conductive layer (layer 2) was made of a composite polymer prepared from a mixture of LiTFSI salt with polyethylene oxide (Mw=5 M) fixing an EO:Li molar ratio of 20:1, and an electronically conductive additive consisting in multi-walled carbon nanotubes (MWCNTs). Said multi-walled carbon nanotubes were added in an amount of 8 wt % with respect to the total weight of said layer 2.

### Example 2. Preparation of Symmetric Li-Metal Cell

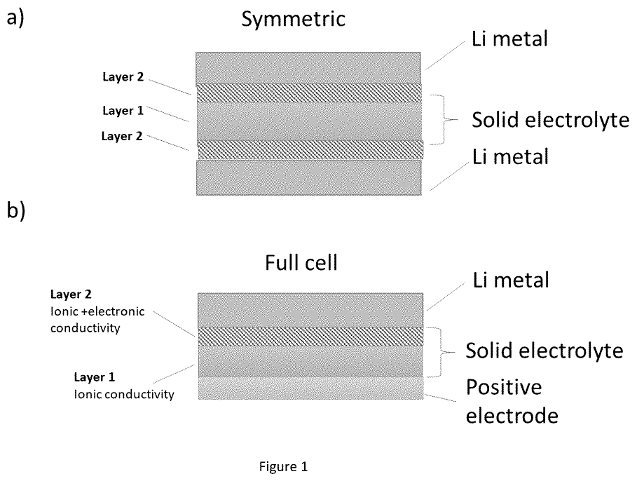

For the assembly of a symmetric cell including the multilayer solid electrolyte the layers as prepared in example 1 were stacked by placing the components on top of each other. FIG. 1a schematizes the assembly of the layers. The ionic conductive and electronically insulating layer (layer 1) is sandwiched between two layers of the ionic and electronic conductive layer (layer 2), then, the whole stack is sandwiched between two disks of lithium metal being the final configuration Li metal/layer2/layer1/layer2/Li metal.

### Example 3. Preparation of the Li-Metal Battery

FIG. 1b shows the Li-metal solid-state battery cell used in the examples consisting of a positive electrode layer, a solid electrolyte comprising the two layers as prepared in example 1 and a Li metal anode.

As can be observed, layer 1 (the one which is ionically conductor and electronically insulator) was placed in contact with the cathode, whereas layer 2 (the one which is ionically and electronically conductor) was placed in contact with the anode).

The positive electrode layer (or cathode layer) was prepared by mixing the active material (LiFePO₄), the conductive additive (CNTs) and the catholyte, this catholyte having the same composition as layer 1 of the solid electrolyte: PEO-Li salt, with an EO:Li molar ratio of 20:1 and where Li salt was LiTFSI.

The lithium metal anode was prepared by cutting a piece of lithium metal foil with the desired size.

For the assembly of the full cell including the multilayer solid electrolyte, the different layers prepared as above were stacked by placing the components on top of each other. As schematized in FIG. 1b, the electrolyte layer 1 was placed on top of the cathode layer, then, the ionic and electronic conductive layer (layer 2) was placed on top of the layer 1 and finally the lithium metal anode was placed on top of layer 2.

### Example 4. Testing of the Solid Electrolyte in Symmetric and Full-Cell Configuration

The stripping-plating abilities of the electrolyte of the invention were tested in symmetric configuration, in which the solid electrolyte layer 1 is sandwiched between layer 2 and Li metal disks as described in example 2 (FIG. 1a).

The symmetric cell was cycled at increasing currents from C/20 up to 4 C with area capacity of 0.5 mAh·cm⁻². The experiments were carried out at 70° C. in order to ensure high ionic conductivity on the PEO-LiTFSI solid electrolyte layer 1 and layer 2.

For comparative purposes, a symmetric cell with only layer 1 as solid electrolyte was also prepared and tested. The comparative symmetric cell was cycled at increasing currents from C/20 up to 4 C with area capacity of 0.2 and 0.5 mAh·cm⁻².

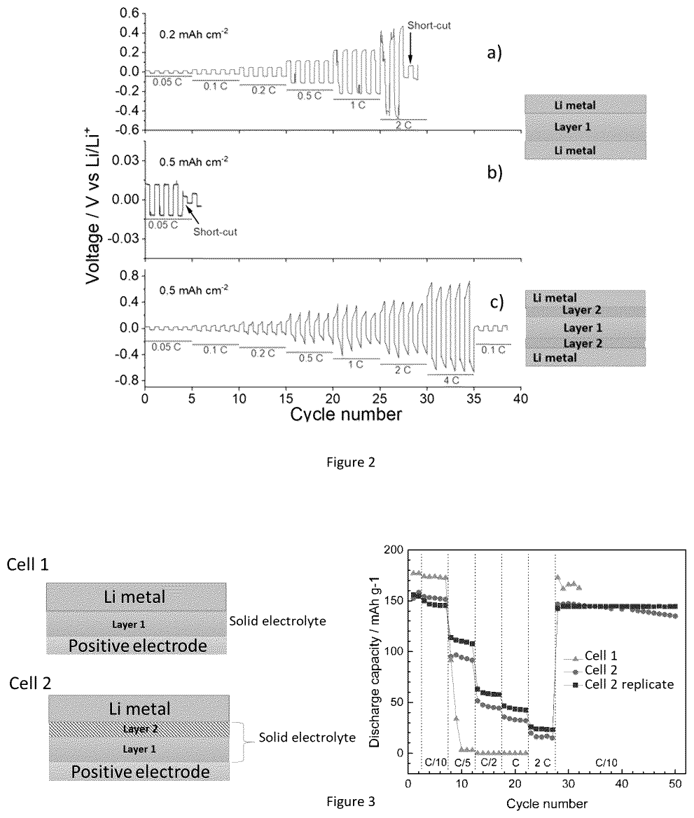

At the low area capacity of 0.2 mAh·cm⁻², the comparative electrolyte withstands up to 1 C before short circuiting at 2 C (FIG. 2a). When the loading is increased to 0.5 mAh·cm⁻², the electrolyte failed after 5 cycles at 0.05 C when the current is increased to 0.1 C (FIG. 2b).

On the contrary, the solid electrolyte of the present invention (FIG. 2c) withstands the whole rate capability from 0.05 C up to 4 C and is able to recover back to 0.1 C with no evidence of dendrite formation.

For the full cell experiments, the solid electrolyte was assembled following the configuration as described in example 3 and displayed in FIG. 1b. The rate capability of the cells with an active material loading of 1.0 mAh·cm⁻² was evaluated at 70° C. from C/20 to 2 C.

Also, for comparative purposes, a standard cell configuration wherein layer 1 is used as electrolyte was also tested.

The electrochemical testing of the full cells was therefore carried out under the configurations Cell 1 and Cell 2 schematically represented in FIG. 3.

Cell 1 displayed discharge capacity at 0.05 C and 0.1 C. At higher currents, the cell did not show any electrochemical activity, likely due to the formation of dendrites.

Cell 2 and its replicate displayed high discharge capacity values from C/20 up to C/5. At higher currents, the discharge capacity decreased but the cell was able to discharge ca. 50 mAh/g at C/2 and 1 C and some electrochemical activity at 2 C. The electrochemical results of Cell 2 highlight the improvement when layer 2 is included at the interface between Li metal and layer 1.

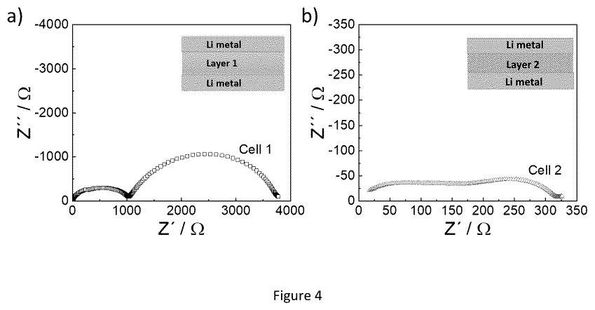

In addition, layer 2 provides a lower resistive interface with Li metal in comparison to layer 1. FIG. 4a-b shows the electrochemical impedance spectroscopy profile of symmetric Li cells with layer 1 (cell 1) and layer 2 (cell 2).

Cell 1 displays two semicircles. The second semicircle appearing at lower frequency is ascribed to the Li metal/Laver 1 interface. The aerial specific resistance (ASR) of this interface is 2100 Ω cm². For the Layer 2, including the electronically conductive additive. the ASR is 120 Ω cm², evidencing the improvement at interfacial level when layer 2 is included.

1. An electrochemical Na- or Li-ion or Na- or Li-metal cell or a Na- or Li-ion or Na- or Li-metal battery comprising a multilayer solid electrolyte for Li- and Na-ion batteries, said multilayer solid electrolyte comprising:
a) an ionic conductive and electronically insulating layer comprising:
an ion conductive polymer, and at least a lithium or a sodium salt; or
an inorganic solid material;
b) an ionic and electronic conductive layer comprising:
an ion conductive polymer, at least a lithium or a sodium salt, and an electronically conductive additive; or
an inorganic solid material and an electronically conductive additive.

2. The electrochemical cell or the battery according to claim 1, wherein the ionic conductive and electronically insulating layer comprises an ion conductive polymer and at least a lithium salt.

3. The electrochemical cell or the battery according to claim 1, wherein the ionic and electronic conductive layer comprises an ion conductive polymer, at least a lithium salt and an electronically conductive additive.

4. The electrochemical cell or the battery according to claim 1, wherein the ion conductive polymer is selected from the group consisting of polyethylene oxide, polypropylene oxide, a polyethylene oxide/polypropylene oxide-grafted poly(alkene-alt-maleic anhydride) polymer, a polyethylene oxide-polypropylene oxide blend, a polyethylene oxide-polypropylene oxide block copolymer, a polyethylene oxide-polypropylene oxide-polyethylene oxide block copolymer, and a polystyrene-polyethylene oxide block polymer.

5. The electrochemical cell or the battery according to claim 1, wherein the ion conductive polymer is polyethylene oxide.

6. The electrochemical cell or the battery according to claim 1, wherein the at least lithium salt is selected from the group consisting of lithium trifluoromethane sulfonate LiCF₃SO₃, lithium bis(trifluoromethanesulfonyl)imide Li[(CF₃SO₂)₂N], lithium bis(perfluoroethylsulfonyl)imide Li[(CF₃CF₂SO₂)₂N], lithium (trifluoromethanesulfonyl)(fluorosulfonyl)imide Li[(CF₃SO₂)(FSO₂)N], Li[(C₂F₅SO₂)₂N], lithium bis(fluorosulfonyl)imide Li[(FSO₂)₂N], Li[(FSO₂)(C₄F₉SO₂)N], and lithium (perfluoroethylsulfonyl)(fluorosulfonyl)imide Li[(FSO₂)(CF₃CF₂SO₂)N].

7. The electrochemical cell or the battery according to claim 1, wherein the electronically conductive additive is selected from the group consisting of carbon, graphite, graphite powder, graphite powder flakes, graphite powder spheroids, carbon black, activated carbon, conductive carbon, amorphous carbon, glassy carbon, acetylene black, single walled carbon nanotubes, multi-walled carbon nanotubes, graphene, graphyne, and any combinations thereof.

8. The electrochemical cell or the battery according to claim 1, wherein the ionic conductive and electronically insulating layer (a) comprises:
a) polyethylene oxide as the ion conductive polymer, and
b) a lithium salt selected from the group consisting of Li[(CF₃SO₂)₂N] and Li[(CF₃SO₂)(FSO₂)N].

9. The electrochemical cell or the battery according to claim 1, wherein the ionic and electronic conductive layer comprises:
a) polyethylene oxide as the ion conductive polymer, and
b) a lithium salt selected from the group consisting of Li[(CF₃SO₂)₂N] and Li[(CF₃SO₂)(FSO₂)N]; and
c) an electronically conductive additive selected from the group consisting of single walled carbon nanotubes, multi-walled carbon nanotubes, graphene, graphite, and carbon black.

10. The electrochemical cell or the battery according to claim 1, comprising:
a) the multilayer solid electrolyte;
b) a negative electrode; and
c) a positive electrode,
wherein the layer a) of the multilayer solid electrolyte is in contact with the positive electrode and the layer b) of the multilayer solid electrolyte is in contact with the negative electrode.

11. The electrochemical cell or the battery according to claim 1, wherein the negative electrode comprises a material selected from the group consisting of metal lithium, a lithium alloy forming material, and a lithium intercalation material.

12. The electrochemical cell or the battery according to claim 1, wherein the positive electrode comprises an active material selected from the group consisting of lithium metal oxides and lithium-based olivines.
